(19) United States
(12) Patent Application Publication
(10) Pub. No.: US 2017/0313130 A1
(43) Pub. Date: Nov. 2, 2017

(54) TIRE PROVIDED WITH A TREAD COMPRISING A THERMOPLASTIC ELASTOMER AND A DIENE ELASTOMER

(71) Applicants: COMPAGNIE GENERALE DES ETABLISSEMENTS MICHELIN, CLERMONT-FERRAND (FR); Michelin Recherche et Technique S.A., GRANGES-PACCOT (CH)

(72) Inventors: CHRISTOPHE CHOUVEL, CLERMONT-FERRAND (FR); EMMANUEL CUSTODERO, CLERMONT-FERRAND (FR); MARC GREIVELDINGER, CLERMONT-FERRAND (FR)

(21) Appl. No.: 15/322,205

(22) PCT Filed: Jun. 26, 2015
(86) PCT No.: PCT/EP2015/064566

§ 371 Date: Dec. 27, 2016

(30) Foreign Application Priority Data
Jun. 30, 2014 (FR) 1456127

(51) Int. Cl. B60C 1/00; C08L 9/06

(52) U.S. Cl. CPC B60C 1/0016; C08L 9/06; C08L 2205/035; C08L 2205/03

(57) ABSTRACT

A tire comprises a tread, a crown with a crown reinforcement, two sidewalls, two beads, a carcass reinforcement anchored to the two beads and extending from one sidewall to the other, characterized in that the tread comprises a composition based on at least one diene elastomer, at a content of between 35 and 99 phr (parts by weight per hundred parts of elastomer), and a thermoplastic elastomer at a content of between 1 and 65 phr, said thermoplastic elastomer being a block copolymer comprising at least one elastomer block of optionally hydrogenated butadiene/styrene random copolymer type and at least one thermoplastic block of styrene type.

The present invention relates to tyres provided with a tread.

In a conventional tyre, the tread comprises, by way of elastomer, diene elastomers. This type of tread is well known and is described in numerous documents.

Treads comprising a mixture of diene elastomer and thermoplastic elastomer have been described in several documents. For example, the document WO 2012/105984 describes tread compositions comprising a styrene/butadiene (SBR) copolymer, a polybutadiene (BR) and an unsaturated thermoplastic styrene (TPS) elastomer and also a reinforcing filler to improve the wear resistance of the tyres.

Within the context of the compromise between improving rolling resistance and improving wet grip of the tyres, the applicants previously described, in document WO 2012/152686, a tyre provided with a tread comprising at least one thermoplastic elastomer, said thermoplastic elastomer being a block copolymer comprising at least one elastomer block and at least one thermoplastic block, the total content of thermoplastic elastomer being within a range varying from 65 to 100 phr (parts by weight per hundred parts of elastomer). In particular, the applicants described a tread comprising, as thermoplastic elastomer, the styrene-isoprene-styrene (SIS) triblock copolymer, this tread enabling a reduction in rolling resistance compared to treads of conventional composition.

A constant aim of tyre manufacturers is to reduce the rolling resistance of tyres.

Now, the applicants have surprisingly found that a tyre provided with a tread comprising a specific thermoplastic elastomer and a diene elastomer made it possible to obtain a very great reduction in rolling resistance.

Therefore, the subject of the invention is a tyre comprising a tread, a crown with a crown reinforcement, two sidewalls, two beads, a carcass reinforcement anchored to the two beads and extending from one sidewall to the other, characterized in that the tread comprises a composition based on at least one diene elastomer, at a content of between 35 and 99 phr (parts by weight per hundred parts of elastomer), a thermoplastic elastomer, at a content of between 1 and 65 phr said thermoplastic elastomer being a block copolymer comprising at least one elastomer block of optionally hydrogenated butadiene/styrene random copolymer type and at least one thermoplastic block of styrene type.

Preferentially, the invention relates to a tyre as defined above, in which the number-average molecular weight of the thermoplastic elastomer is between 30 000 and 500 000 g/mol.

Also preferentially, the invention relates to a tyre as defined above, in which the elastomer block(s) of the block copolymer are chosen from elastomers having a glass transition temperature of less than 25° C.

Still preferentially, the invention relates to a tyre as defined above, in which the SBR elastomer block(s) have a styrene content within a range extending from 10% to 60%. Preferably, the SBR elastomer block(s) have a content of 1,2-bonds for the butadiene part within a range extending from 4 mol % to 75 mol % and a content of 1,4-bonds within a range extending from 20 mol % to 96 mol %. Also preferably, the SBR elastomer block(s) are hydrogenated such that a proportion extending from 25 mol % to 100 mol % of the double bonds in the butadiene portion are hydrogenated, more preferentially a proportion extending from 50 mol % to 100 mol % and preferably from 80 mol % to 100 mol % of the double bonds in the butadiene portion are hydrogenated.

Preferentially, the invention relates to a tyre as defined above, in which the thermoplastic styrene block(s) of the block copolymer are chosen from polymers having a glass transition temperature of greater than 80° C. and, in the case of a semicrystalline thermoplastic block, a melting point of greater than 80° C. Preferably, the fraction of thermoplastic styrene block in the block copolymer is within a range extending from 5% to 70%. Preferably, the thermoplastic block(s) of the block copolymer are chosen from polystyrenes, preferentially from polystyrenes obtained from styrene monomers selected from the group consisting of unsubstituted styrene, substituted styrenes and mixtures thereof, and more preferentially from polystyrenes obtained from styrene monomers selected from the group consisting of unsubstituted styrene, methylstyrenes, para-tert-butyl styrene, chlorostyrenes, bromostyrenes, fluorostyrenes, para-hydroxystyrene and mixtures thereof. Very preferentially, the thermoplastic block(s) of the block copolymer are chosen from polystyrenes obtained from styrene monomers selected from the group consisting of unsubstituted styrene, o-methylstyrene, m-methylstyrene, p-methylstyrene, alpha-methylstyrene, alpha,2-dimethylstyrene, alpha,4-dimethylstyrene, diphenyl ethylene, para-tert-butyl styrene, o-chlorostyrene, m-chlorostyrene, p-chlorostyrene, 2,4-dichlorostyrene, 2,6-dichlorostyrene, 2,4,6-trichlorostyrene, o-bromostyrene, m-bromostyrene, p-bromostyrene, 2,4-dibromostyrene, 2,6-dibromostyrene, 2,4,6-tribromostyrene, o-fluorostyrene, m-fluorostyrene, p-fluorostyrene, 2,4-difluorostyrene, 2,6-difluorostyrene, 2,4,6-trifluorostyrene, para-hydroxystyrene and mixtures thereof. More preferentially, the thermoplastic block(s) of the block copolymer are obtained from unsubstituted polystyrene.

The invention preferentially relates to a tyre as defined above, in which the diene elastomer (that is to say the diene elastomer or elastomers) is selected from the group consisting of essentially unsaturated diene elastomers and mixtures thereof. The diene elastomer is preferably selected from the group consisting of homopolymers obtained by polymerization of a conjugated diene monomer having from 4 to 12 carbon atoms, copolymers obtained by copolymerization of one or more conjugated dienes with one another or with one or more vinylaromatic compounds having from 8 to 20 carbon atoms, and mixtures thereof. The diene elastomer is more preferentially selected from the group consisting of polybutadienes, synthetic polyisoprenes, natural rubber, butadiene copolymers, isoprene copolymers and mixtures of these elastomers. The diene elastomer is very preferentially selected from the group consisting of copolymers of butadiene and styrene.

The invention preferentially relates to a tyre as defined above, in which the content of diene elastomer is within a range extending from 40 to 90 phr and the content of thermoplastic elastomer is within a range extending from 10 to 60 phr. Preferentially, the content of diene elastomer is within a range extending from 50 to 80 phr and the content of thermoplastic elastomer is within a range extending from 20 to 50 phr. More preferentially, the content of diene elastomer is within a range extending from 55 to 70 phr and the content of thermoplastic elastomer is within a range extending from 30 to 45 phr.

The invention also preferentially relates to a tyre as defined above, in which the tread composition also comprises reinforcing filler, at a content of less than 80 phr, preferably less than 60 phr. The content of reinforcing filler is preferably from 3 to 50 phr, preferably from 5 to 40 phr. Preferentially, the reinforcing filler is carbon black and/or silica. According to a preferred embodiment, the predominant reinforcing filler is silica. Alternatively and also preferentially, the predominant reinforcing filler is carbon black.

The invention preferably relates to a tyre as defined above, in which the tread composition does not contain a plasticizing system or comprises same with a total plasticizer content of less than 20 phr, preferably less than 15 phr. More preferentially, the tread composition does not comprise a plasticizing system or comprises same with a total plasticizer content of less than 10 phr, preferably less than 5 phr.

The invention preferentially relates to a tyre as defined above, in which the tread composition also comprises a crosslinking system.

The invention relates more particularly to the tyres intended to equip motorless vehicles, such as bicycles, or motor vehicles of the following types: passenger vehicles, SUVs (Sport Utility Vehicles), two-wheel vehicles (in particular motorcycles), aircraft, as well as industrial vehicles chosen from vans, heavy-duty vehicles—that is to say, underground trains, buses, heavy road transport vehicles (lorries, tractors, trailers) or off-road vehicles, such as agricultural vehicles or earthmoving equipment—, or other transportation or handling vehicles.

### DETAILED DESCRIPTION OF THE INVENTION

In the present description, unless expressly indicated otherwise, all the percentages (%) shown are percentages by weight.

Furthermore, the term “phr” means, within the meaning of the present patent application, parts by weight per hundred parts of elastomer, thermoplastic and non-thermoplastic elastomers mixed together. Within the meaning of the present invention, thermoplastic elastomers (TPEs) are included among the elastomers.

Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

Finally, when reference is made to a “predominant” compound, within the context of the present invention this means that this compound is predominant among the compounds of the same type in the composition, that is to say it is the one which represents the largest amount by weight among the compounds of the same type. Thus, for example, a predominant reinforcing filler is the reinforcing filler representing the greatest weight relative to the total weight of reinforcing fillers in the composition. On the other hand, a “minority” compound is a compound which does not represent the greatest weight fraction among the compounds of the same type.

### 1. Composition of the Tread

The essential feature of the tyre according to the invention is that it comprises a tread, a crown with a crown reinforcement, two sidewalls, two beads, a carcass reinforcement anchored to the two beads and extending from one sidewall to the other, in which the tread comprises a composition based on at least one diene elastomer, at a content of between 35 and 99 phr (parts by weight per hundred parts of elastomer), a thermoplastic elastomer with a content between 1 and 65 phr, said thermoplastic elastomer being a block copolymer comprising at least one elastomer block of optionally hydrogenated butadiene/styrene random copolymer type and at least one thermoplastic block of styrene type.

1.1 Specific Thermoplastic Elastomer (TPE) with SBR and PS Blocks

Generally, thermoplastic elastomers (abbreviated to “TPEs”) have a structure intermediate between elastomers and thermoplastic polymers. These are block copolymers composed of rigid thermoplastic blocks connected via flexible elastomer blocks.

For the requirements of the invention, said specific thermoplastic elastomer is a block copolymer comprising at least one optionally hydrogenated butadiene/styrene random copolymer-type (SBR) elastomer block and at least one styrene copolymer-type (PS) thermoplastic block. In the following text, when reference is made to an SBR block, this is therefore an elastomeric block composed predominantly (that is to say to more than 50% by weight, preferably to more than 80% by weight) of a butadiene/styrene random copolymer, this copolymer possibly being or not being hydrogenated, and when reference is made to a styrene block, this is a block composed predominantly (that is to say to more than 50% by weight, preferably to more than 80% by weight) of a styrene polymer such as a polystyrene.

1.1.1. Structure of the TPE with SBR and PS Blocks

The number-average molecular weight (denoted Mₙ) of the TPE with SBR and PS blocks is preferentially between 30 000 and 500 000 g/mol, more preferentially between 40 000 and 400 000 g/mol. Below the minima indicated, there is a risk of the cohesion between the SBR elastomer chains of the TPE with SBR and PS blocks being affected, especially due to its possible dilution (in the presence of an extending oil); furthermore, there is a risk of an increase in the working temperature affecting the mechanical properties, especially the properties at break, with the consequence of a reduced “hot” performance. Furthermore, an excessively high weight Mₙ can be detrimental for the processing. Thus, it has been observed that a value within a range from 50 000 to 300 000 g/mol, and better still from 60 000 to 150 000 g/mol, was particularly well suited, especially to use of the TPE with SBR and PS blocks in a tyre tread composition.

The number-average molecular weight (Mₙ) of the TPE elastomer with SBR and PS blocks is determined in a known way by size exclusion chromatography (SEC). For example, in the case of thermoplastic styrene elastomers, the sample is dissolved beforehand in tetrahydrofuran at a concentration of approximately 1 g/l and then the solution is filtered through a filter with a porosity of 0.45 μm before injection. The apparatus used is a Waters Alliance chromatographic line. The elution solvent is tetrahydrofuran, the flow rate is 0.7 ml/min, the temperature of the system is 35° C. and the analytical time is 90 min. A set of four Waters columns in series, with the Styragel tradenames (HMW7, HMW6E and two HT6E), is used. The injected volume of the solution of the polymer sample is 100 μl. The detector is a Waters 2410 differential refractometer, and its associated software for making use of the chromatographic data is the Waters Millennium system. The calculated average molar masses are relative to a calibration curve produced with polystyrene standards. The conditions can be adjusted by those skilled in the art.

The value of the polydispersity index PI (reminder: PI=M_{w}/Mₙ, with M_{w} the weight-average molecular weight and Mₙ the number-average molecular weight) of the TPE with SBR and PS blocks is preferably less than 3, more preferentially less than 2 and even more preferentially less than 1.5.

In a known way, TPEs with SBR and PS blocks have two glass transition temperature peaks (T_{g}, measured according to ASTM D3418), the lowest temperature being relative to the SBR elastomer part of the TPE with SBR and PS blocks and the highest temperature being relative to the thermoplastic PS part of the TPE with SBR and PS blocks. Thus, the flexible SBR blocks of the TPEs with SBR and PS blocks are defined by a T_{g} which is less than ambient temperature (25° C.), while the rigid PS blocks have a T_{g} which is greater than 80° C.

In the present application, when reference is made to the glass transition temperature of the TPE with SBR and PS blocks, this is the T_{g} relative to the SBR elastomer block. The TPE with SBR and PS blocks preferentially has a glass transition temperature (“T_{g}”) which is preferentially less than or equal to 25° C., more preferentially less than or equal to 10° C. A T_{g} value greater than these minima can reduce the performance of the tread when used at very low temperature; for such a use, the T_{g} of the TPE with SBR and PS blocks is more preferentially still less than or equal to −10° C. Also preferentially, the T_{g} of the TPE with SBR and PS blocks is greater than −100° C.

The TPEs with SBR and PS blocks can be copolymers with a small number of blocks (less than 5, typically 2 or 3), in which case these blocks preferably have high weights of greater than 15 000 g/mol. These TPEs with SBR and PS blocks can, for example, be diblock copolymers, comprising one thermoplastic block and one elastomer block. They are often also triblock elastomers with two rigid segments connected by one flexible segment. The rigid and flexible segments can be positioned linearly, or in a star or branched configuration. Typically, each of these segments or blocks often contains at least more than 5, generally more than 10, base units (for example, styrene units and butadiene/styrene units for a styrene/SBR/styrene block copolymer).

The TPEs with SBR and PS blocks can also comprise a large number of smaller blocks (more than 30, typically from 50 to 500), in which case these blocks preferably have relatively low weights, for example from 500 to 5000 g/mol; these TPEs with SBR and PS blocks will subsequently be referred to as multiblock TPEs with SBR and PS blocks and are an elastomer block/thermoplastic block series.

According to a first variant, the TPE with SBR and PS blocks is in a linear form. For example, the TPE with SBR and PS blocks is a diblock copolymer: PS block/SBR block. The TPE with SBR and PS blocks can also be a triblock copolymer: PS block/SBR block/PS block, that is to say one central elastomer block and two terminal thermoplastic blocks, at each of the two ends of the elastomer block. Equally, the multiblock TPE with SBR and PS blocks can be a linear series of SBR elastomer blocks/thermoplastic PS blocks.

According to another variant of the invention, the TPE with SBR and PS blocks of use for the requirements of the invention is in a star-branched form comprising at least three branches. For example, the TPE with SBR and PS blocks can then be composed of a star-branched SBR elastomer block comprising at least three branches and of a thermoplastic PS block located at the end of each of the branches of the SBR elastomer block. The number of branches of the central elastomer can vary, for example, from 3 to 12 and preferably from 3 to 6.

According to another variant of the invention, the TPE with SBR and PS blocks is provided in a branched or dendrimer form. The TPE with SBR and PS blocks can then be composed of a branched or dendrimer SBR elastomer block and of a thermoplastic PS block located at the end of the branches of the dendrimer elastomer block.

### 1.1.2. Nature of the Elastomer Blocks

For the requirements of the invention, the elastomer blocks of the TPE with SBR and PS blocks may be all the elastomers of butadiene/styrene random copolymer type (SBR) known to those skilled in the art.

The fraction of SBR elastomer block in the TPE with SBR and PS blocks is within a range extending from 30% to 95%, preferentially from 40% to 92% and more preferentially from 50% to 90%.

These SBR blocks preferably have a T_{g} (glass transition temperature) measured by DSC according to standard ASTM D3418, 1999, of less than 25° C., preferentially less than 10° C., more preferentially less than 0° C. and very preferentially less than −10° C. Also preferentially, the T_{g} of the SBR blocks is greater than −100° C. SBR blocks having a T_{g} of between 20° C. and −70° C., and more particularly between 0° C. and −50° C., are especially suitable.

In a well known way, the SBR block comprises a styrene content, a content of 1,2-bonds of the butadiene part and a content of 1,4-bonds of the butadiene part, the latter being composed of a content of trans-1,4-bonds and a content of cis-1,4-bonds when the butadiene part is not hydrogenated.

Preferentially, use is especially made of an SBR block having a styrene content for example within a range extending from 10% to 60% by weight, preferably from 20% to 50% by weight, and for the butadiene part, a content of 1,2-bonds within a range extending from 4% to 75% (mol %) and a content of 1,4-bonds within a range extending from 20% to 96% (mol %).

Depending on the degree of hydrogenation of the SBR block, the content of double bonds in the butadiene part of the SBR block can decrease as far as a content of 0 mol % for a completely hydrogenated SBR block. Preferably, in the TPEs with SBR and PS blocks of use for the requirements of the invention, the SBR elastomer block is hydrogenated such that a proportion ranging from 25 mol % to 100 mol % of the double bonds in the butadiene portion are hydrogenated. More preferentially, from 50 mol % to 100 mol % and very preferentially from 80 mol % to 100 mol % of the double bonds in the butadiene portion are hydrogenated.

Within the meaning of the present invention, the styrene part of the SBR blocks may be composed of monomers chosen from styrene monomers, and especially selected from the group consisting of unsubstituted styrene, substituted styrenes and mixtures thereof. Among the substituted styrenes, those selected from the group consisting of methylstyrenes (preferentially o-methylstyrene, m-methylstyrene and p-methylstyrene, alpha-methylstyrene, alpha,2-dimethylstyrene, alpha,4-dimethylstyrene and diphenylethylene), para-tert-butyl styrene, chlorostyrenes (preferentially o-chlorostyrene, m-chlorostyrene, p-chlorostyrene, 2,4-dichlorostyrene, 2,6-dichlorostyrene and 2,4,6-trichlorostyrene), bromostyrenes (preferentially o-bromostyrene, m-bromostyrene, p-bromostyrene, 2,4-dibromostyrene, 2,6-dibromostyrene and 2,4,6-tribromostyrene), fluorostyrenes (preferentially o-fluorostyrene, m-fluorostyrene, p-fluorostyrene, 2,4-difluorostyrene, 2,6-difluorostyrene and 2,4,6-trifluorostyrenes), para-hydroxystyrene and mixtures thereof will preferentially be chosen.

According to a preferential embodiment of the invention, the elastomer blocks of the TPE with SBR and PS blocks have, in total, a number-average molecular weight (“Mₙ”) ranging from 25 000 g/mol to 350 000 g/mol, preferably from 35 000 g/mol to 250 000 g/mol, so as to confer, on the TPE with SBR and PS blocks, good elastomeric properties and sufficient mechanical strength compatible with the use as tyre tread.

The elastomer block can also be composed of several elastomer blocks as defined above.

### 1.1.3. Nature of the Thermoplastic Blocks

Use will be made, for the definition of the thermoplastic blocks, of the characteristic of glass transition temperature (T_{g}) of the rigid thermoplastic block. This characteristic is well known to those skilled in the art. It makes it possible especially to choose the industrial processing (transformation) temperature. In the case of an amorphous polymer (or polymer block), the processing temperature is chosen to be substantially greater than the T_{g}. In the specific case of a semicrystalline polymer (or a polymer block), a melting point may be observed which is then greater than the glass transition temperature. In this case, it is instead the melting point (M.p.) which makes it possible to choose the processing temperature for the polymer (or polymer block) under consideration. Thus, subsequently, when reference will be made to “T_{g} (or M.p., if appropriate)”, it will be necessary to consider that this is the temperature used to choose the processing temperature.

For the requirements of the invention, the TPE elastomers with SBR and PS blocks comprise one or more thermoplastic block(s) preferably having a T_{g} (or M.p., if appropriate) of greater than or equal to 80° C. and composed of polymerized styrene (PS) monomers. Preferentially, this thermoplastic block has a T_{g} (or M.p., if appropriate) within a range varying from 80° C. to 250° C. Preferably, the T_{g} (or M.p., if appropriate) of this thermoplastic block is preferentially from 80° C. to 200° C., more preferentially from 80° C. to 180° C.

The fraction of PS thermoplastic block in the TPE with SBR and PS blocks is within a range extending from 5% to 70%, preferentially from 8% to 60% and more preferentially from 10% to 50%.

The thermoplastic blocks of the TPE with SBR blocks are polystyrene blocks. The preferential polystyrenes are obtained from styrene monomers selected from the group consisting of unsubstituted styrene, substituted styrenes and mixtures thereof. Among the substituted styrenes, those selected from the group consisting of methylstyrenes (preferentially o-methylstyrene, m-methylstyrene and p-methylstyrene, alpha-methyl styrene, alpha,2-dimethylstyrene, alpha,4-dimethylstyrene and di phenyl ethylene), para-tert-butyl styrene, chlorostyrenes (preferentially o-chlorostyrene, m-chlorostyrene, p-chlorostyrene, 2,4-dichlorostyrene, 2,6-dichlorostyrene and 2,4,6-trichlorostyrene), bromostyrenes (preferentially o-bromostyrene, m-bromostyrene, p-bromostyrene, 2,4-dibromostyrene, 2,6-dibromostyrene and 2,4,6-tribromostyrene), fluorostyrenes (preferentially o-fluorostyrene, m-fluorostyrene, p-fluorostyrene, 2,4-difluorostyrene, 2,6-difluorostyrene and 2,4,6-trifluorostyrene), para-hydroxystyrene and mixtures thereof will preferentially be chosen.

Very preferentially, the thermoplastic blocks of the TPE with SBR blocks are blocks obtained from unsubstituted polystyrene.

According to a variant of the invention, the polystyrene block as defined above can be copolymerized with at least one other monomer, so as to form a thermoplastic block having a T_{g} (or M.p., if appropriate) as defined above.

By way of illustration, this other monomer capable of copolymerizing with the polymerized monomer can be chosen from diene monomers, more particularly conjugated diene monomers having from 4 to 14 carbon atoms, and monomers of vinylaromatic type having from 8 to 20 carbon atoms.

According to the invention, the thermoplastic blocks of the TPE with SBR and PS blocks have, in total, a number-average molecular weight (“Mₙ”) ranging from 5000 g/mol to 150 000 g/mol, so as to confer, on the TPE with SBR and PS blocks, good elastomeric properties and sufficient mechanical strength compatible with the use as tyre tread.

The thermoplastic block can also be composed of several thermoplastic blocks as defined above.

1.1.4. Examples of TPE with SBR and PS Blocks

By way of examples of commercially available TPE elastomers with SBR and PS blocks, mention may be made of SOE-type elastomers, sold by Asahi Kasei under the name SOE S1611, SOE L605, or else SOE L606.

1.1.5. Amount of TPE with SBR and PS Blocks

In the tyre tread composition of the invention, the TPE elastomer (i.e. the TPE elastomer or elastomers) with SBR and PS blocks represents between 1 and 65%, preferably from 10 to 60% by weight, more preferentially from 20 to 50% and very preferentially from 30 to 45% by weight of all the elastomers present in the elastomer composition.

Thus, the amount of TPE elastomer with SBR and PS blocks is within a range which varies between 1 and 65 phr, preferentially from 10 to 60 phr, better still from 20 to 50 phr and especially from 30 to 45 phr. Indeed, with an amount of TPE elastomer with SBR and PS blocks of less than 1 phr, the effect on the reduction in rolling resistance is hardly noteworthy, while beyond 65 phr of TPE elastomer with SBR and PS blocks, the composition adopts a thermoplastic nature, consequently giving rise to a large change in the properties with temperature.

### 1.2. Diene Elastomer

The composition of the tread according to the invention comprises at least one (that is to say, one or more) diene rubber. The total content of diene elastomer is between 35 and 99 phr, preferably within a range varying from 40 to 90 phr, preferentially from 50 to 80 phr, more preferentially from 55 to 70 phr.

The term “diene” elastomer or rubber should be understood, in a known way, as meaning an (one or more is understood) elastomer resulting at least in part (i.e., a homopolymer or a copolymer) from diene monomers (monomers bearing two conjugated or non-conjugated carbon-carbon double bonds).

These diene elastomers can be classified into two categories: “essentially unsaturated” or “essentially saturated”.

“Essentially unsaturated” is generally understood as meaning a diene elastomer resulting at least in part from conjugated diene monomers having a content of units of diene origin (conjugated dienes) which is greater than 15% (mol %). In the category of “essentially unsaturated” diene elastomers, the term “highly unsaturated” diene elastomer is understood as meaning in particular a diene elastomer having a content of units of diene origin (conjugated dienes) which is greater than 50%.

Thus it is that diene elastomers such as some butyl rubbers or copolymers of dienes and of alpha-olefins of EPDM type can be described as “essentially saturated” diene elastomers (low or very low content of units of diene origin, always less than 15%).

Given these definitions, diene elastomer, irrespective of the above category, capable of being used in the compositions in accordance with the invention is understood more particularly as meaning:

(a)—any homopolymer obtained by polymerization of a conjugated diene monomer having from 4 to 12 carbon atoms;
(b)—any copolymer obtained by copolymerization of one or more conjugated dienes with one another or with one or more vinylaromatic compounds having from 8 to 20 carbon atoms;
(c)—a ternary copolymer obtained by copolymerization of ethylene and of an α-olefin having from 3 to 6 carbon atoms with a non-conjugated diene monomer having from 6 to 12 carbon atoms, such as, for example, the elastomers obtained from ethylene and propylene with a non-conjugated diene monomer of the abovementioned type, such as, especially, 1,4-hexadiene, ethylidenenorbornene or dicyclopentadiene;
(d)—a copolymer of isobutene and isoprene (diene butyl rubber) and also the halogenated versions, in particular chlorinated or brominated versions, of this type of copolymer.

Any type of diene elastomer can be used in the invention. When the composition comprises a vulcanization system, use is preferably made of essentially unsaturated elastomers, in particular of the (a) and (b) types above, in the manufacture of the tread of the tyre according to the present invention.

The following are especially suitable as conjugated dienes: 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene. The following, for example, are suitable as vinylaromatic compounds: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene.

The copolymers can comprise between 99% and 20% by weight of diene units and between 1% and 80% by weight of vinylaromatic units. The elastomers can have any microstructure, which depends on the polymerization conditions used, especially on the presence or absence of a modifying and/or randomizing agent and on the amounts of modifying and/or randomizing agent employed. The elastomers can, for example, be prepared in dispersion or in solution; they can be coupled and/or star-branched or else functionalized with a coupling and/or star-branching or functionalization agent. For coupling to carbon black, mention may be made, for example, of functional groups comprising a C—Sn bond or aminated functional groups, such as benzophenone, for example; for coupling to a reinforcing inorganic filler, such as silica, mention may be made, for example, of silanol functional groups or polysiloxane functional groups having a silanol end (such as described, for example, in FR 2 740 778 or U.S. Pat. No. 6,013,718), alkoxysilane groups (such as described, for example, in FR 2 765 882 or U.S. Pat. No. 5,977,238), carboxyl groups (such as described, for example, in WO 01/92402 or U.S. Pat. No. 6,815,473, WO 2004/096865 or US 2006/0089445) or else polyether groups (such as described, for example, in EP 1 127 909 or U.S. Pat. No. 6,503,973). As other examples of functionalized elastomers, mention may also be made of elastomers (such as SBR, BR, NR or IR) of the epoxidized type.

### 1.3. Nanometric or Reinforcing Filler

The elastomer(s) described above are sufficient by themselves for the tread according to the invention to be usable. Preferentially, the composition according to the invention can also comprise a reinforcing filler.

When a reinforcing filler is used, use may be made of any type of filler commonly used for the manufacture of tyres, for example an organic filler, such as carbon black, an inorganic filler, such as silica, or else a blend of these two types of filler, in particular a blend of carbon black and silica. Preferentially, for the purposes of the invention, the predominant reinforcing filler could be silica, or alternatively carbon black.

All the carbon blacks conventionally used in tyres (“tyre-grade” blacks) are suitable as carbon blacks. Mention will more particularly be made, for example, of the reinforcing carbon blacks of the 100, 200 or 300 series (ASTM grades), such as, for example, the N115, N134, N234, N326, N330, N339, N347 or N375 blacks, or else, depending on the applications targeted, the blacks of higher series (for example N660, N683 or N772), indeed even N990.

“Reinforcing inorganic filler” should be understood, in the present application, by definition, as meaning any inorganic or mineral filler, irrespective of its colour and its origin (natural or synthetic), also known as “white filler”, “clear filler” or indeed even “non-black filler”, in contrast to carbon black, capable of reinforcing by itself, without means other than an intermediate coupling agent, a rubber composition intended for the manufacture of tyres, in other words capable of replacing, in its reinforcing role, a conventional tyre-grade carbon black; such a filler is generally characterized, in a known way, by the presence of hydroxyl (—OH) groups at its surface.

The physical state in which the reinforcing inorganic filler is provided is not important, whether it is in the form of a powder, of micropearls, of granules, of beads or any other appropriate densified form. Of course, reinforcing inorganic filler is also understood as meaning mixtures of different reinforcing inorganic fillers, in particular of highly dispersible siliceous and/or aluminous fillers as described below.

Mineral fillers of the siliceous type, in particular silica (SiO₂), or of the aluminous type, in particular alumina (Al₂O₃), are suitable in particular as reinforcing inorganic fillers. The silica used can be any reinforcing silica known to those skilled in the art, especially any precipitated or fumed silica having a BET surface area and a CTAB specific surface area both of less than 450 m²/g, preferably from 30 to 400 m²/g. By way of highly dispersible precipitated silicas (“HDSs”), mention will be made, for example, of the Ultrasil 7000 and Ultrasil 7005 silicas from Degussa, the Zeosil 1165MP, 1135MP and 1115MP silicas from Rhodia, the Hi-Sil EZ150G silica from PPG, the Zeopol 8715, 8745 and 8755 silicas from Huber or the silicas having a high specific surface area as described in application WO 03/16837.

In order to couple the reinforcing inorganic filler to the elastomer, it is possible, for example, to use, in a known way, an at least bifunctional coupling agent (or bonding agent) intended to provide a satisfactory connection, of chemical and/or physical nature, between the inorganic filler (surface of its particles) and the elastomer, in particular bifunctional organosilanes or polyorganosiloxanes.

The content by volume of optional reinforcing filler in the composition (carbon black and/or reinforcing inorganic filler, such as silica) is within a range from 0% to 20%, which corresponds to a content of 0 to 50 phr for a plasticizer-free composition. Preferentially, the composition comprises less than 80 phr of reinforcing filler (especially between 1 and 80 phr), preferably less than 60 phr (especially between 1 to 60 phr), more preferentially a content within a range extending from 3 to 50 phr, better still from 5 to 40 phr.

### 1.4 Plasticizers

The elastomer or elastomers described above are sufficient alone for the tread according to the invention to be useable.

Thus, according to one preferential embodiment of the invention, the elastomer composition described above does not comprise plasticizing agent of oil or thermoplastic resin type, or, if it does comprise same, it comprises less than 20 phr (especially between 0.5 and 20 phr), preferably less than 15 phr (especially between 0.5 and 15 phr), more preferentially less than 10 phr (especially between 0.5 and 10 phr), better still less than 5 phr (especially between 0.5 and 5 phr) thereof. Also preferentially, the composition does not comprise plasticizing agent. In a manner known to those skilled in the art, plasticizing agent refers to a plasticizing oil (or plasticizing oil or extender oil) or resin, the function of which is to facilitate the processing of the tread, particularly the integration thereof into the tyre by lowering the modulus and increasing the tackifying power.

Use may be made of any oil, preferably having a weakly polar nature, capable of extending or plasticizing elastomers, especially thermoplastic elastomers. At ambient temperature (23° C.), these oils, which are more or less viscous, are liquids (that is to say, as a reminder, substances which have the ability to eventually assume the shape of their container), in contrast in particular to resins or rubbers, which are by nature solid. Use may also be made of any type of plasticizing resin known to those skilled in the art.

Those skilled in the art will know, in the light of the description and exemplary embodiments which follow, how to adjust the amount of plasticizer as a function of the TPE elastomer with SBR and PS blocks used (as indicated above) and of the specific conditions of use of the tyre provided with the tread, and especially as a function of the pneumatic article in which it is intended to be used.

### 1.5. Various Additives

The thermoplastic elastomer(s) described above are sufficient by themselves for the tread according to the invention to be usable.

Nonetheless, according to one preferential embodiment of the invention, the elastomer composition described above can also comprise the various additives usually present in treads known to those skilled in the art. One or more additives will be chosen, for example, selected from protecting agents, such as antioxidants or antiozonants, UV stabilizers, various processing aids or other stabilizing agents, or else promoters capable of promoting the adhesion to the remainder of the structure of the pneumatic object.

Equally and optionally, the composition of the tread of the invention can contain a crosslinking system known to those skilled in the art, such as a vulcanization system comprising sulphur or a sulphur-donating agent, and optionally one or more vulcanization activators and/or accelerators.

### 2. Preparation

The tread compositions for the tyre according to the invention are manufactured in appropriate mixers, using two successive phases of preparation well known to those skilled in the art: a first phase of thermomechanical working or kneading (sometimes referred to as “non-productive” phase) at high temperature, up to a maximum temperature of between 110° C. and 190° C., preferably between 130° C. and 180° C., followed by a second phase of mechanical working (sometimes referred to as “productive” phase) at a lower temperature, typically of less than 110° C., for example between 60° C. and 100° C., during which finishing phase the crosslinking or vulcanization system is incorporated; such phases have been described, for example in applications EP-A-0501227, EP-A-0735088, EP-A-0810258, WO 00/05300 or WO 00/05301. The TPE elastomers with SBR and PS blocks are introduced during the first step, directly in their commercially available form, for example in the form of beads or granules.

The tread for the tyre according to the invention is then extruded in the conventional way, in order to produce the profiled element. The tread pattern is then applied in the mould for curing the tyre.

This tread may be mounted on a tyre in a conventional way, said tyre comprising, in addition to the tread according to the invention, a crown, two sidewalls and two beads, a carcass reinforcement anchored to the two beads, and a crown reinforcement.

### Exemplary Embodiments of the Invention

Tread compositions for a tyre according to the invention were prepared as indicated above.

### Tests Carried Out in the Laboratory on the Compositions

Dynamic Properties

The dynamic properties G* and tan(δ)max are measured on a viscosity analyser (Metravib V A4000) according to Standard ASTM D 5992-96. The response of a sample of vulcanized composition (cylindrical test specimen with a thickness of 4 mm and a cross section of 400 mm²), subjected to a simple alternating sinusoidal shear stress, at a frequency of 10 Hz, under standard temperature conditions (23° C.) according to Standard ASTM D 1349-99, is recorded. A peak-to-peak strain amplitude sweep is carried out from 0.1% to 50% (outward cycle) and then from 50% to 1% (return cycle). The results made use of are the complex dynamic shear modulus (G*) and the loss factor (tan δ). The maximum value of tan δ observed (tan(δ)ₘₐₓ) and the difference in complex modulus (ΔG*) between the values at 0.1% and at 50% strain (Payne effect) are shown for the return cycle.

For the value of tan (δ)ₘₐₓ at 23° C., the lower the value, the weaker the hysteresis of the composition will be and hence the lower the rolling resistance will be. For greater readability, the results will be shown according to performance in base 100, the value 100 being assigned to the control. A result of less than 100 indicates a reduction in the rolling resistance performance (increase in the tan(δ)ₘₐₓ value at 23° C.) and conversely a result of greater than 100 will indicate an increase in the performance (decrease in the tan(δ)ₘₐₓ value at 23° C.).

Dynamic Friction Coefficient

The measurements of the dynamic friction coefficient were carried out according to a method identical to that described by L. Busse, A. Le Gal, and M. Küppel (Modelling of Dry and Wet Friction of Silica Filled Elastomers on Self-Affine Road Surfaces, Elastomere Friction, 2010, 51, p. 8). The test specimens were produced by moulding, then vulcanization of a square test specimen (50 mm×50 mm) having a thickness of 6 mm. After closing the mould, the latter is placed in a press with heated plates at 150° C. for 50 minutes, at a pressure of 16 bar. The ground used for carrying out these measurements is a core removed from an actual road surface made of asphalt concrete of VTAC (very thin asphalt concrete) type (standard NF P 98-137). The test specimen is subjected to a sliding movement in translation parallel to the plane of the ground. The sliding velocity SV is set at 0.03 m/sec. The applied normal stress sn is 100 kPa. These conditions are described hereinbelow by “wet ground conditions”. The tangential stress st opposed to the movement of the test specimen over the ground is measured continuously. The ratio between the tangential stress st and the normal stress sn gives the dynamic friction coefficient μ. The values indicated in the table below are the dynamic friction coefficient values obtained at steady state after stabilization of the value of the tangential stress st. For greater readability, the results will be shown according to performance in base 100, the value 100 being assigned to the control. A result of less than 100 indicates a reduction in the dry grip performance and conversely a result of greater than 100 will indicate an increase in the dry grip performance.

### Tests Carried Out on Tyres

Tyres according to the invention were then prepared according to the usual methods, with conventional constituents known to those skilled in the art: a crown, two sidewalls and two beads, a carcass reinforcement anchored to the two beads, a crown reinforcement and a tread, the tread being that described for the purposes of the present invention.

The properties of the tyres according to the invention may be evaluated by tests carried out on tyres as indicated below.

Test for Measuring Rolling Resistance

The rolling resistance of the tyres was measured on a flywheel, according to the ISO 87-67 (1992) method. For greater readability, the results will be shown in terms of performance in base 100, the value 100 being assigned to the control. A result of less than 100 indicates a reduction in the performance in question and conversely a result of greater than 100 will indicate an increase in the performance in question, that is to say a reduction in the rolling resistance.

Test for Measuring Wear Resistance

The wear resistance of the tyres was measured by a “rolling on a circuit” trial, with a small heavy goods vehicle of IVECO 4305 FL brand with a theoretical load of 1850 kg/tyre at the rear and 1150 kg/tyre at the front, everything with a pressure of 7 bar. The circuit is travelled under conditions which make it possible to wear the tyres in a manner reproducible between the control and the solution tested: the vehicles move in convoy, which guarantees that the tyres are subjected to the same conditions of speed, of accelerations, of temperature and of nature of the ground. The rolling circuit is travelled until a distance of greater than 2500 km is achieved.

The front right-hand tyre of the vehicle is considered. The control tyre and the solution tested are weighed before running and after more than 2500 km. The weight lost by the control sets a wear performance at 100%. A solution having a value of greater than 100 represents an improved result, that is to say a lower weight lost.

Grip Test: Braking on Dry Ground with an ABS System

The tyres are fitted to a small heavy goods vehicle of brand Canter, model 6C15, each axle being ballasted to its maximum permitted weight, and the distance necessary to go from 90 km/h to 20 km/h is measured during abrupt braking on dry ground (asphalt concrete). A solution having a value of greater than 100 represents an improved result, that is to say a shorter braking distance.

### Example

Tyre tread compositions in accordance with the invention (A1, A2, A3 and A4) were prepared as indicated above and compared to a control: a control tyre tread composition (A0). The compositions of these treads are presented in table 1 below.

TABLE 1

| Composition | A-0 | A-1 | A-2 | A-3 | A-4 |
|---|---|---|---|---|---|
| BR (1) | 15 | 15 | 15 | 0 | 0 |
| SBR (2) | 85 | 51 | 51 | 60 | 60 |
| TPE elastomer (3) | 0 | 34 | 34 | 40 | 40 |
| Carbon black (4) | 5 | 5 | 5 | 5 | 5 |
| Silica (5) | 70 | 70 | 26 | 26 | 26 |
| Coupling agent (6) | 6 | 6 | 2 | 2 | 2 |
| Oil (7) | 2 | 2 | 0 | 2 | 0 |
| Resin (8) | 15 | 15 | 0 | 15 | 0 |
| Anti-ozone wax | 1.5 | 1.5 | 1.5 | 1.5 | 1.5 |
| Antioxidant (9) | 2 | 2 | 2 | 2 | 2 |
| DPG (10) | 1.3 | 1.3 | 0.5 | 0.5 | 0.5 |
| ZnO (11) | 0.5 | 0.5 | 0.5 | 0.5 | 0.5 |
| Stearic acid (12) | 2 | 2 | 2 | 2 | 2 |
| CBS (13) | 1.7 | 1.7 | 1.7 | 1.7 | 1.7 |
| Sulphur | 1 | 1 | 1 | 1 | 1 |

(1) BR with 4% 1,2 units and 93% cis-1,4 units (Tg = −106° C.;
(2) SSBR solution (contents expressed as dry SBR: 41% styrene, 24% 1,2-polybutadiene units and 50% trans-1,4-polybutadiene units (Tg = −25° C.);
(3) SOE thermoplastic elastomer, SOE L606 from Asahi Kasei;
(4) Carbon black N234;
(5) Silica (Zeosil 1165MP from Rhodia);
(6) Coupling agent, TESTP (Si69 from Degussa);
(7) MES oil, Catenex SNR from Shell;
(8) C₅/C₉ resin, CrayValley Wingtack from STS;
(9) N-(1,3-Dimethylbutyl)-N-phenyl-para-phenylenediamine (Santoflex 6-PPD from Flexsys);
(10) DPG = diphenylguanidine (Perkacit DPG from Flexsys);
(11) Zinc oxide (industrial grade, Umicore);
(12) Stearin (Pristerene from Uniqema);
(13) N-Cyclohexyl-2-benzothiazolesulphenamide (Santocure CBS from Flexsys).

It is possible to note, in these compositions, the possibility of lowering the content of reinforcing filler and of plasticizer with respect to the control composition, by virtue of the use of TPE elastomers with SBR and PS blocks in blend with the diene elastomer in the tread composition.

The performance properties of the invention were evaluated in the laboratory, and the results are presented in table 2 below.

TABLE 2

| Composition | A-0 | A-1 | A-2 | A-3 | A-4 |
|---|---|---|---|---|---|
| Hysteresis | 100 | 96 | 161 | 154 | 185 |
| performance | | | | | |
| (base 100) | | | | | |
| Dry grip | 100 | 101 | 108 | 108 | 100 |
| performance | | | | | |
| (base 100) | | | | | |

The results present in table 2 demonstrate that the compositions according to the invention make it possible, without degrading performance (A1), to replace some of the diene elastomer with a TPE with SBR and PS blocks, and even enable a notable improvement in the balance of performance properties (A2 to A4) which can be expected in terms of rolling resistance and braking on dry ground. Moreover, it is very surprising in light of the prior art that the TPE with SBR and PS blocks in blend with a diene elastomer make it possible to notably reduce the amount of filler and of plasticizer in the tread composition, thereby enabling an economy of means and ease of use.

The performance properties of the invention were then evaluated on a tyre (225/75 R16). To this end, a tyre B1 provided with a tread of composition A4 in accordance with the invention was compared to a control B0 provided with a tread of composition A0. These tyres were evaluated in rolling resistance, wear and braking on dry ground tests. The results are given in table 3.

TABLE 3

| | Tyre | |
|---|---|---|
| | B-0 | B-1 |
| | Formulation of the tread | |
| | A-0 | A-4 |
| Rolling resistance performance (base 100) | 100 | 119 |
| Wear performance (base 100) | 100 | 101 |
| Dry braking performance (base 100) | 100 | 99 |

The results given in table 3 demonstrate that the tread of composition A4 according to the invention enables a notable improvement in rolling resistance performance, while retaining similar performance in wear resistance and in braking on dry ground.

1.-28. (canceled)

29. A tire comprising a tread, a crown with a crown reinforcement, two sidewalls, two beads, a carcass reinforcement anchored to the two beads and extending from one sidewall to the other, wherein the tread comprises a composition based on:
at least one diene elastomer at a content of between 35 and 99 phr, and
a thermoplastic elastomer at a content between 1 and 65 phr, said thermoplastic elastomer being a block copolymer comprising at least one elastomer block of optionally hydrogenated butadiene/styrene random copolymer type and at least one thermoplastic block of styrene type,
wherein phr is parts by weight per hundred parts of elastomer.

30. The tire according to claim 29, wherein the number-average molecular weight of the thermoplastic elastomer is between 30,000 and 500,000 g/mol.

31. The tire according to claim 29, wherein the elastomer blocks of the block copolymer are chosen from elastomers having a glass transition temperature of less than 25° C.

32. The tire according to claim 29, wherein the at least one elastomer block of optionally hydrogenated butadiene/styrene random copolymer type has a styrene content within a range extending from 10% to 60%.

33. The tire according to claim 29, wherein the at least one elastomer block of optionally hydrogenated butadiene/styrene random copolymer type has a content of 1,2-bonds for the butadiene part within a range extending from 4 mol % to 75 mol % and a content of 1,4-bonds within a range extending from 20 mol % to 96 mol %.

34. The tire according to claim 29, wherein the at least one elastomer block of optionally hydrogenated butadiene/styrene random copolymer type is hydrogenated such that a proportion extending from 25 mol % to 100 mol % of the double bonds in the butadiene portion are hydrogenated.

35. The tire according to claim 34, wherein at least one elastomer block of optionally hydrogenated butadiene/styrene random copolymer type is hydrogenated such that a proportion extending from 50 mol % to 100 mol % of the double bonds in the butadiene portion are hydrogenated.

36. The tire according to claim 34, wherein at least one elastomer block of optionally hydrogenated butadiene/styrene random copolymer type is hydrogenated such that a proportion extending from 80 mol % to 100 mol % of the double bonds in the butadiene portion are hydrogenated.

37. The tire according to claim 29, wherein the at least one thermoplastic block of styrene type is chosen from polymers having a glass transition temperature of greater than 80° C. and, in the case of a semicrystalline thermoplastic block, a melting point of greater than 80° C.

38. The tire according to claim 29, wherein the fraction of the at least one thermoplastic block of styrene type in the block copolymer is within a range extending from 5% to 70%.

39. The tire according to claim 29, wherein the at least one thermoplastic block of styrene type is chosen from polystyrenes.

40. The tire according to claim 39, wherein the at least one thermoplastic block of styrene type is chosen from polystyrenes obtained from styrene monomers selected from the group consisting of unsubstituted styrene, substituted styrenes and mixtures thereof.

41. The tire according to claim 40, wherein the at least one thermoplastic block of styrene type is chosen from polystyrenes obtained from styrene monomers selected from the group consisting of unsubstituted styrene, methylstyrenes, para-tert-butyl styrene, chlorostyrenes, bromostyrenes, fluorostyrenes, para-hydroxystyrene and mixtures thereof.

42. The tire according to claim 41, wherein the at least one thermoplastic block of styrene type is chosen from polystyrenes obtained from styrene monomers selected from the group consisting of unsubstituted styrene, o-methylstyrene, m-methylstyrene, p-methylstyrene, alpha-methyl styrene, alpha,2-dimethylstyrene, alpha,4-dimethylstyrene, diphenylethylene, para-tert-butylstyrene, o-chlorostyrene, m-chlorostyrene, p-chlorostyrene, 2,4-dichlorostyrene, 2,6-dichlorostyrene, 2,4,6-trichlorostyrene, o-bromostyrene, m-bromostyrene, p-bromostyrene, 2,4-dibromostyrene, 2,6-dibromostyrene, 2,4,6-tribromostyrene, o-fluorostyrene, m-fluorostyrene, p-fluorostyrene, 2,4-difluorostyrene, 2,6-difluorostyrene, 2,4,6-trifluorostyrene, para-hydroxystyrene and mixtures thereof.

43. The tire according to claim 42, wherein the at least one thermoplastic block of styrene type is obtained from unsubstituted polystyrene.

44. The tire according to claim 29, wherein the at least one diene elastomer is selected from the group consisting of essentially unsaturated diene elastomers and mixtures thereof.

45. The tire according to claim 44, wherein the at least one diene elastomer is selected from the group consisting of homopolymers obtained by polymerization of a conjugated diene monomer having from 4 to 12 carbon atoms, copolymers obtained by copolymerization of one or more conjugated dienes with one another or with one or more vinylaromatic compounds having from 8 to 20 carbon atoms, and mixtures thereof.

46. The tire according to claim 45, wherein the at least one diene elastomer is selected from the group consisting of polybutadienes, synthetic polyisoprenes, natural rubber, butadiene copolymers, isoprene copolymers and mixtures thereof.

47. The tire according to claim 29, wherein the content of the at least one diene elastomer is within a range extending from 40 to 90 phr and the content of the thermoplastic elastomer is within a range extending from 10 to 60 phr.

48. The tire according to claim 47, wherein the content of the at least one diene elastomer is within a range extending from 50 to 80 phr and the content of the thermoplastic elastomer is within a range extending from 20 to 50 phr.

49. The tire according to claim 48, wherein the content of the at least one diene elastomer is within a range extending from 55 to 70 phr and the content of the thermoplastic elastomer is within a range extending from 30 to 45 phr.

50. The tire according to claim 29, wherein the tread composition further comprises reinforcing filler, at a content of less than 80 phr.

51. The tire according to claim 50, wherein the content of reinforcing filler is less than 60 phr.

52. The tire according to claim 51, wherein the content of reinforcing filler is from 3 to 50 phr.

53. The tire according to claim 52, wherein the content of reinforcing filler is from 5 to 40 phr.

54. The tire according to claim 50, wherein the reinforcing filler is carbon black, silica or a combination of carbon black and silica.

55. The tire according to claim 54, wherein the predominant reinforcing filler is silica.

56. The tire according to claim 55, wherein the predominant reinforcing filler is carbon black.

57. The tire according to claim 29, wherein the tread composition does not contain a plasticizing system.

58. The tire according to claim 29, wherein the tread composition further comprises a plasticizing system with a plasticizer content of less than 20 phr.

59. The tire according to claim 58, wherein the plasticizer content is less than 15 phr.

60. The tire according to claim 59, wherein the plasticizer content is less than 10 phr.

61. The tire according to claim 60, wherein the plasticizer content is less than 5 phr.

62. The tire according to claim 60, wherein the tread composition further comprises a crosslinking system.
